(19) United States
(12) Patent Application Publication
(10) Pub. No.: US 2011/0215907 A1
(43) Pub. Date: Sep. 8, 2011

(54) RADIO FREQUENCY IDENTIFCATION (RFID) TAG AND OPERATION METHOD THEREOF, AND SYSTEM AND METHOD FOR CONTROLLING NETWORK ACCESS BASED ON MOBILE RFID

(75) Inventors: Kwang Soo Cho, Daejeon (KR); Chan Won Park, Daejeon (KR); Ji Hoon Bae, Daejeon (KR); Josef Preishuber-Pfluegl, Klagenfurt (AT); David Tschische, Klagenfurt (AT)

(73) Assignees: Electronics and Telecommunications Research Institute, Daejeon (KR); CISC Semiconductor Design+Consulting GmbH, Klagenfurt (AT)

(21) Appl. No.: 13/041,980

(22) Filed: Mar. 7, 2011

(30) Foreign Application Priority Data
Mar. 5, 2010 (KR) 10-2010-0019957
Dec. 2, 2010 (KR) 10-2010-0121780

(51) Int. Cl. G06K 7/01

(52) U.S. Cl. 340/10.1

(57) ABSTRACT

Disclosed are a radio frequency identification (RFID) tag capable of supplying an Internet service quickly and conveniently, an operation method thereof, and a system and method for controlling network access based on a mobile RFID. Network access data is generated by communication between an RFID terminal and an RFID tag. The mobile RFID terminal connects with a network gateway by reading the network access data, thereby supplying the Internet service quickly and conveniently.

### CROSS-REFERENCE TO RELATED APPLICATION

This application claims the benefit of Korean Patent Application No. 10-2010-0019957 and of Korean Patent Application No. 10-2010-0121780, respectively filed on Mar. 5, 2010 and Dec. 2, 2010, in the Korean Intellectual Property Office, the disclosure of which is incorporated herein by reference.

### BACKGROUND

1. Field

Example embodiments of the following description relate to a method for controlling network access using a radio frequency identification (RFID) tag and an RFID reader.

2. Description of the Related Art

Generally, in a radio-frequency identification (RFID) scheme, information is extracted from or written on an RFID tag which contains specific identification (ID) information, without physical contact and using a wireless frequency, thereby enabling recognition, tracking, and management of an object, an animal, a person, and the like having the RFID tag attached. The above RFID scheme is being applied to various services.

An RFID system using the RFID scheme is achieved using a plurality of RFID tags, for example, electronic tags or transponders, each containing specific ID information and being attached to an object or an animal, and an RFID reader or interrogator for reading and writing of the ID information of the tags. The RFID systems may be classified into a mutual induction type and an electromagnetic wave type depending on a communication method between the RFID reader and the RFID tag. Also, the RFID systems may be classified into an active type and a passive type depending on whether the RFID tag is powered by an integrated power source or by the RFID reader or interrogator. Depending on a used frequency, the RFID system may also be classified into a long wave type, a medium wave type, a short wave type, and an ultra-short wave type.

Recently, a relatively large number of companies are supplying free wired or wireless network access service for further convenience of their customers. However, various restrictions may be conditions are applied to prevent overuse of the network. For example, in most stores or shops, a network access control scheme is available within a predetermined area close to a counter. Customers having made a purchase may be required to pass by a point of sale to receive a receipt, a coupon, or a token for use of the network.

In the case of using a wireless Internet platform for interoperability (WIPI) system, an encoded system identifier (ID), for example, a wired equivalent privacy (WEP), a Wi-Fi protected access (WPA), or a service set ID (SSID), is used to allow or disallow customers' access to the network service.

However, a conventional scheme as described above has a few drawbacks. First, the customers may have to wait at the point of sale to obtain access information. When access to the network is managed and an access key having permission rights is periodically updated, waiting time of the customers will increase. An unexpected increase in a number of clerks may be necessary to carry out incidental tasks.

In addition, a network access scheme using an individual sales key supplied with a receipt may be less feasible than a conventional network access scheme using an access key. Moreover, customers unfamiliar with the network access scheme may be confused and have to ask for technical help from clerks. As a result, additional expenses and efforts may be induced, thereby reducing economic efficiency.

Thus, it has been almost impractical to use a single integrated access key on a public domain because people who obtain the access key once, whether legitimately or illicitly, may use the network free of charge out of a shop area. In this case, overuse the network may be caused. Also, uncontrollable traffic may be generated, thereby reducing the network performance.

### SUMMARY

The foregoing and/or other aspects are achieved by providing a system for to controlling network access, including a radio frequency identification (RFID) tag to generate network access data and to supply the generated network access data; and a mobile RFID terminal to read the network access data from the RFID tag through an RFID air interface, and to supply an Internet service using the network access data.

The system may further include a network gateway to receive the network access data from the mobile RFID terminal, to check validity of the network access data, and to control the Internet service supplied to the mobile RFID terminal based on a result of the check.

The network gateway may interrupt the Internet service to the mobile RFID when the network access data is determined to be invalid.

The RFID tag may compare a current time with an expiry date and time included in the network access data to determine whether the expiry date and time has passed, deletes the network access data when the expiry date and time has passed, and newly generates second network access data.

The RFID tag may transmit the second network access data to the network gateway.

The foregoing and/or other aspects are achieved by providing an RFID tag including a generation module to generate network access data and to store the network access data in a memory, a transmission module to supply the generated network access data to a mobile RFID terminal and a network gateway, and a control module to check validity of the network access data and, based on a result of the check, to determine whether to newly generate second network access data.

The control module may compare an expiry date and time included in the network access data with a current time by using a real time clock (RTC) to determine whether the expiry date and time has passed, delete the access data from the memory when the expiry date and time has passed, and newly generate second network access data.

The foregoing and/or other aspects are achieved by providing a method for controlling network access, including generating network access data in an RFID tag, reading the network access data from the RFID tag through an RFID air interface in a mobile RFID terminal, and supplying an Internet service using the network access data in the mobile RFID terminal.

The foregoing and/or other aspects are achieved by providing a method for operating an RFID tag, including generating network access data, storing the generated network access data in a memory, checking validity of the network access data, and determining whether to newly generate second network access data based on a result of the check.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of a structure of a system for controlling network access, according to example embodiments;

FIG. 2 illustrates a flowchart for describing a method of controlling network access, according to example embodiments;

FIG. 3 illustrates a block diagram of a structure of a radio frequency identification (RFID) tag according to example embodiments; and

FIG. 4 illustrates a flowchart for describing a method for operating the RFID tag of FIG. 3.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

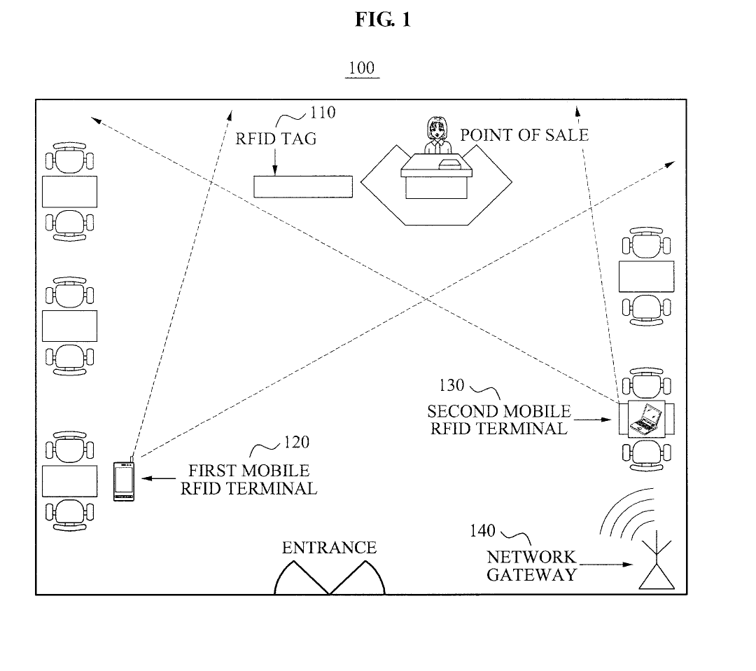

FIG. 1 illustrates a block diagram of a structure of a system 100 for controlling network access, according to example embodiments.

Referring to FIG. 1, the network access control system 100 include a radio frequency identification (RFID) tag 110, mobile RFID terminals 120 and 130, and a network gateway 140.

The RFID tag 110 generates network access data. For example, the RFID tag 110 may generate the network access data using a random number generator (RNG). The network access data may include a network ID, a network key, and an expiry date and time.

The RFID tag 110 is disposed in a center of a network operation area. For example, the RFID tag 110 may be disposed near a point of sale in a restaurant or a shop or disposed in an area covering all data necessary for the network access.

The mobile RFID terminals 120 and 130 may read the network access data from the RFID tag 110 through an RFID air interface. According to example embodiments, the mobile RFID terminals 120 and 130 may each include a mobile reader. The mobile reader may retrieve network access data from the RFID tag 110 during an inventory round. Actual communication is performed by the RFID air interface to retrieve a logical memory structure of the RFID tag 110.

The mobile RFID terminals 120 and 130 supply an Internet service using the read network access data. Specifically, the mobile RFID terminals 120 and 130 may supply the Internet service by connecting with the network gateway 140 using the network access data and then logging in the network.

Here, the RFID tag 110 and the RFID terminals 120 and 130 basically need to support international organization for standardization/international electrotechnical commission (ISO/IEC) 29143 air interface.

The network gateway 140 may receive the network access data from the mobile RFID terminals 120 and 130 and check validity of the network access data.

For example, the network gateway 140 may check the validity of the network access data by comparing an expiry date and time included in the network access data with a current time to determine whether the expiry date and time has passed. In this case, the network gateway 140 may determine the network access data is valid when the expiry date and time has not passed, and determine the network access data is invalid when the expiry date and time has passed.

According to another example, the network gateway 140 may store in advance the network access data received from the RFID tag 110. Therefore, upon receiving the network access data from the mobile RFID terminals 120 and 130, the network gateway 140 may check the validity of the network access data by comparing the stored network access data with the received network access data. In this case, the network gateway 140 may determine the network access data to be valid when the stored network access data is identical to the received network access data, and determine the network access data to be invalid when the stored network access data is different from the received network access data.

Accordingly, the network gateway 140 may control the Internet service with respect to the mobile RFID terminals 120 and 130. For example, when the network access data received from a first mobile RFID terminal 120 is determined to be valid, the network gateway 140 may supply the Internet service to the first mobile RFID terminal 120. Here, the first mobile RFID terminal 120 may be supplied with the Internet service by connecting with the network through the network gateway 140.

When the network access data received from the second mobile RFID terminal 130 is determined to be invalid, the network gateway 140 may interrupt the Internet service to the second mobile RFID terminal 130. In this case, the second mobile RFID terminal 130 is incapable of connecting with the network and being supplied with the Internet service.

The RFID tag 110 may compare the expiry date and time included in the network access data with the current time, for example by using a real time clock (RTC), to determine whether the expiry date has passed. When the expiry date and time has passed, the RFID tag 110 may delete the network access data and newly generate second network access data. The RFID tag 110 may transmit the second network access data to the network gateway 140. The network gateway 140 may store the second network access data, and control the Internet service with respect to the mobile RFID terminals 120 and 130 by comparing the stored second network access data with network access data received from the mobile RFID terminals 120 and 130.

According to other example embodiments, the network gateway 140 may reduce the time based validity in retrieving the network access data stored in the RFID tag 110 by two methods. First, the RFID tag 110 may directly generate new network access data and automatically prove an error. Second, new network access data may be generated at the outside of the RFID tag 110 while the RFID tag 110 is reprogrammed using an existing RFID reader.

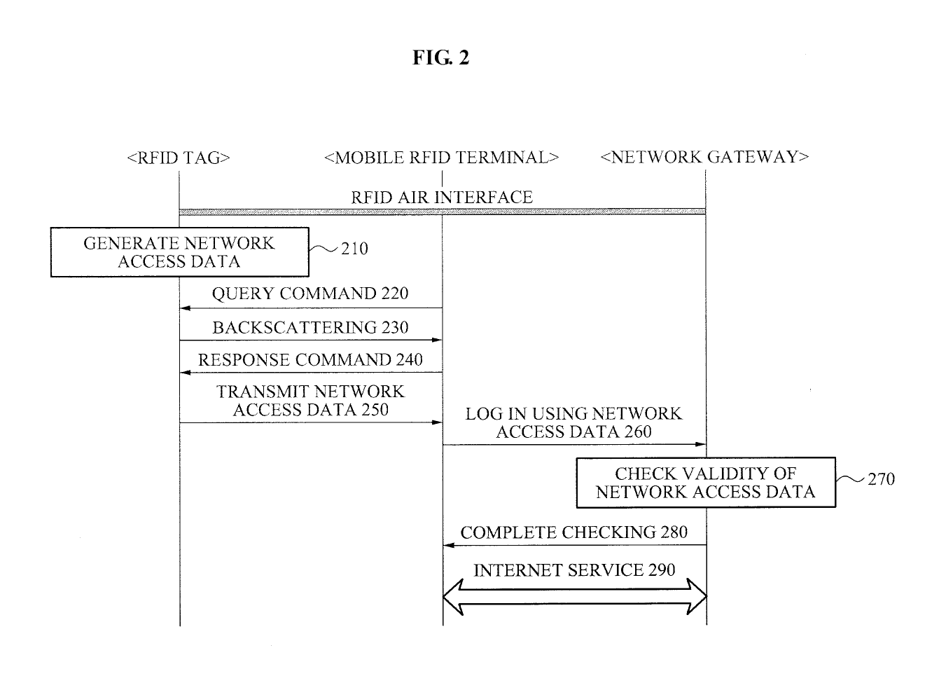

FIG. 2 illustrates a flowchart for describing a method of controlling network access according to example embodiments.

Referring to FIG. 2, an RFID tag 110, a mobile RFID terminal 120, and a network gateway 140 may communicate with one another through an RFID air interface.

In operation 210, the RFID tag 110 generates the network access data. The network access data may include a network ID, a network key, and an expiry date and time.

In operation 220, the mobile RFID terminal 120 may transmit a query command to the RFID tag 110. The mobile RFID terminal 120 performs an inventory round to recognize the RFID tag 110 around. During the inventory round, the query command may be transmitted to the RFID tag 110.

In operation 230, the RFID tag 110 receives the query command and, in response to the query command, transmits a 16-bit random number to the mobile RFID terminal 120 through backscattering.

In operation 240, the mobile RFID terminal 120 may transmit a response command regarding the received random number to the RFID tag 110. Here, when a collision occurs between responses to the query command, the mobile RFID terminal 120 may recognize the RFID tag 110 again using an anti-collision algorithm.

In operation 250, when the RFID tag 110 may transmit the network access data to the mobile RFID terminal 120 upon receiving the response command.

In operation 260, the mobile RFID terminal 120 may try logging in the network gateway 140 using the transmitted network access data. In other words, the mobile RFID terminal 120 may transmit the transmitted network access data to the network gateway 140.

In operation 270, the network gateway 140 may check validity of the transmitted network access data. As described above, the network gateway 140 may store the network access data received from the RFID tag 110 in advance and, upon receiving the network access data from the mobile RFID terminal 120, may compare the stored network access data with the received network access data to check the validity of the network access data.

In operation 280, when the validity of the network access data is determined, the network gateway 140 may inform the mobile RFID terminal 120 that the validity is determined. For example, the network gateway 140 may determine the network access data to be valid when the stored network access data is identical to the received network access data, and determine the network access data to be invalid when the stored network access data is different from the received network access data.

In operation 290, the mobile RFID terminal 120 may connect with the network through the network gateway 140 when the validity is determined, thereby supplying the Internet service.

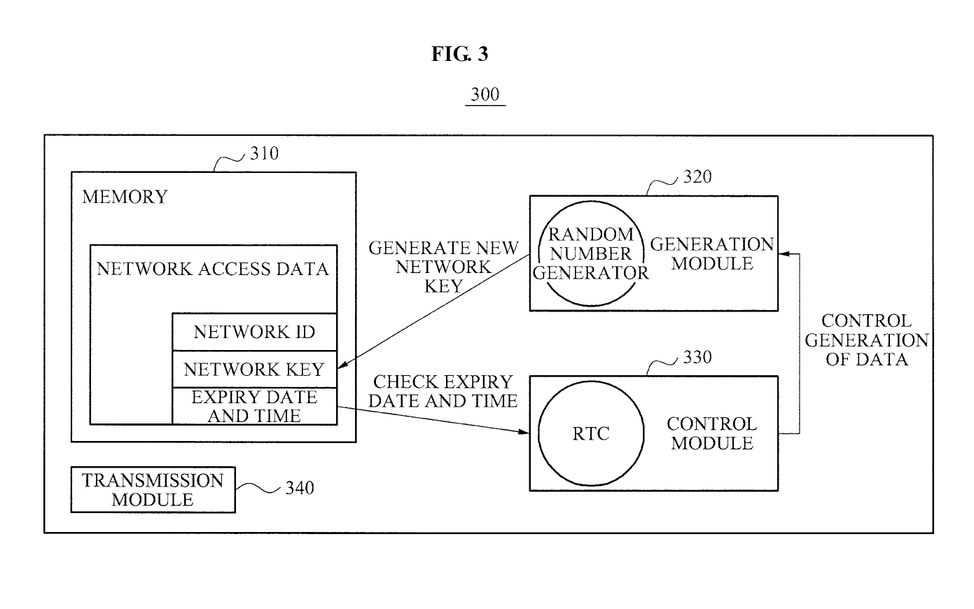

FIG. 3 illustrates a block diagram of a structure of an RFID tag according to example embodiments.

Referring to FIG. 3, an RFID tag 300 may include a memory 310, a generation module 320, a control module 330, and a transmission module 340.

The generation module 320 generates network access data. For example, the generation module 320 may generate the network access data including a network ID, a network key, and an expiry date and time using a random number generator. The generation module 320 may store the generated network access data in the memory 310.

The transmission module 340 may transmit the generated network access data to the mobile RFID terminal 120 and the network gateway 140.

The control module 330 checks the validity of the network access data and thereby determines whether to newly generate second network access data. For example, the control module 330 may check the validity of the network access data by comparing the expiry date and time of the network access data with a current time by using an RTC to determine whether the expiry date and time has passed. If the expiry date and time has passed, the control module 330 may control the generation module 320 to delete the network access data stored in the memory 310 and newly generate the second network access data.

Accordingly, the generation module 320 may generate the second network access data having a new network key using the random number generator, and store the generated second network access data in the memory 310. In addition, the transmission module 340 may supply the second network access data to the network gateway 140.

For example, a BroadCastSynch command defined by ISO/IEC 29143 may be periodically transmitted from the outside of the RFID tag 300 to guarantee accuracy of the RTC.

In addition, when the second network access data is newly generated, the transmission module 340 may transmit a status change message to the network gateway 140 so that a network access policy is corrected. That is, the mobile RFID terminal set to be connected by previous network access data may be automatically disconnected.

For example, the mobile RFID terminal 120 may acquire or interrupt the second network access data on an RFID air interface using a lock mechanism. The lock mechanism may be embodied by applying a tag emulation device structure to the RFID tag 300.

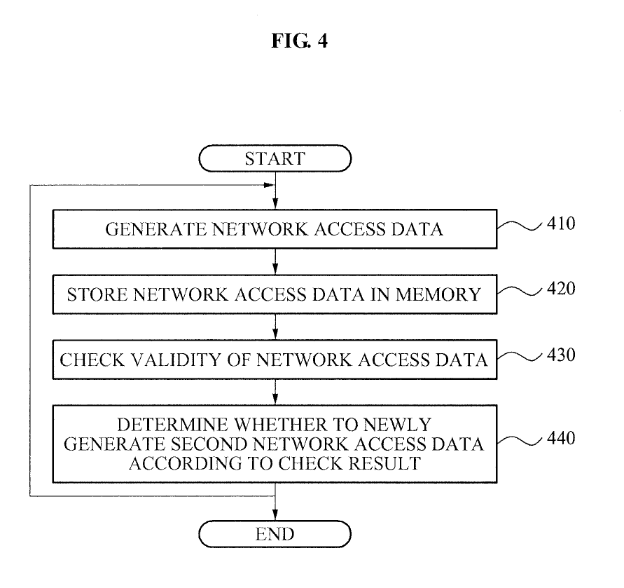

FIG. 4 illustrates a flowchart for describing a method for operating the RFID tag 300 of FIG. 3.

Referring to FIG. 4, the RFID tag 300 generates network access data in operation 410. For example, the RFID tag 300 may generate the network access data including a network ID, a network key, and an expiry date and time using a random number generator.

In operation 420, the RFID tag 300 may store the generated network access data in a memory 310.

In operation 430, the RFID tag 300 checks validity of the network access data. Here, the RFID tag 300 may determine validity of the network access data by comparing an expiry date and time included in the network access data with a current time using an RTC, to determine whether the expiry date and time has passed.

In operation 440, the RFID tag 300 determines whether to newly generate second network access data based on a result of the check. For example, when the expiry date and time has passed, the RFID tag 300 may delete the network access data stored in the memory 310 and newly generate the second network access data.

The method for controlling network access data based on the mobile RFID is not limited only to the above-described embodiments but applicable to all types of ultra high frequency (UHF) band RFID environments. Also, various alterations of the embodiments are practicable within the scope of the invention.

According to example embodiments, the network access may be controlled by processing the network access data through interaction between an RFID tag and a mobile RFID terminal, for example, a mobile phone.

According to example embodiments, the mobile RFID terminal reads the network access data generated by the RFID tag, and an Internet service is supplied through a network gateway using the read network access data. Therefore, access to the network may be achieved quickly and conveniently.

According to example embodiments, since the network access is controlled by controlling the RFID tag, cost for maintaining and repairing the network may be reduced while simplifying the network structure.

According to example embodiments, validity of the network access data is checked and new network access data is generated based on a result of the check. As a result, the network access may be managed more securely.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A system for controlling network access, comprising:
a radio frequency identification (RFID) tag to generate network access data and to supply the generated network access data; and
a mobile RFID terminal to read the network access data from the RFID tag through an RFID air interface, and to supply an Internet service using the network access data.

2. The system of claim 1, further comprising a network gateway to receive the network access data from the mobile RFID terminal, to check validity of the network access data, and to control the Internet service supplied to the mobile RFID terminal based on a result of the check.

3. The system of claim 2, wherein the network gateway interrupts the Internet service to the mobile RFID when the network access data is determined to be invalid.

4. The system of claim 1, wherein the RFID tag compares a current time with an expiry date and time included in the network access data to determine whether the expiry date and time has passed, deletes the network access data when the expiry date and time has passed, and newly generates second network access data.

5. The system of claim 4, wherein the RFID tag transmits the second network access data to the network gateway.

6. A radio frequency identification (RFID) tag comprising:
a generation module to generate network access data and to store the network access data in a memory;
a transmission module to supply the generated network access data to a mobile RFID terminal and a network gateway; and
a control module to check validity of the network access data and, based on a result of the check, to determine whether to newly generate second network access data.

7. The RFID tag of claim 6, wherein the control module compares an expiry date and time included in the network access data with a current time by using a real time clock (RTC) to determine whether the expiry date and time has passed, deletes the access data to from the memory when the expiry date and time has passed, and newly generates second network access data.

8. A method for controlling network access, comprising:
generating network access data in a radio frequency identification (RFID) tag;
reading the network access data from the RFID tag through an RFID air interface in a mobile RFID terminal; and
supplying an Internet service using the network access data in the mobile RFID terminal.

9. The method of claim 8, further comprising:
receiving the network access data from the mobile RFID terminal in a network gateway;
checking validity of the network access data in the network gateway; and
controlling the Internet service supplied to the mobile RFID terminal based on a result of the check.

10. The method of claim 9, wherein the controlling of the Internet service comprises interrupting the Internet service supplied to the mobile RFID terminal when the network access data is determined to be invalid.

11. The method of claim 8, further comprising:
comparing an expiry date and time included in the network access data with a current time in the RFID tag to determine whether the expiry date and time has passed;
deleting the network access data when the expiry date and time has passed;
newly generating second network access data in the RFID tag; and
transmitting the second network access data to a network gateway in the RFID tag.

12. A method for operating a radio frequency identification (RFID) tag, comprising:
generating network access data;
storing the generated network access data in a memory;
checking validity of the network access data; and
determining whether to newly generate second network access data based on a result of the check.

13. The method of claim 12, wherein the checking of the validity of the network access data comprises comparing an expiry date and time included in the network access data with a current time using a real time clock (RTC) to determine whether the expiry date and time included in the network access data has passed.

14. The method of claim 13, wherein the determining of whether to newly generate second network access data comprises:
deleting the network access data from the memory when the expiry date and time has passed; and
controlling to newly generate the second network access data.

15. The method of claim 12, further comprising supplying the second network access data to either a mobile RFID terminal or a network gateway.
